(19) United States
(12) Patent Application Publication
(10) Pub. No.: US 2012/0132220 A1
(43) Pub. Date: May 31, 2012

(54) ARTIFICIAL NAIL WITH THREE-DIMENSIONAL ORNAMENT AND MANUFACTURING METHOD THEREOF

(76) Inventor: Sung Yong Chang, Roslyn Heights, NY (US)

(21) Appl. No.: 12/980,889

(22) Filed: Dec. 29, 2010

(30) Foreign Application Priority Data
Nov. 26, 2010 (KR) 10-2010-0118829

(51) Int. Cl. A45D 31/00; B32B 38/10

(52) U.S. Cl. 132/73; 156/256

(57) ABSTRACT

Provided is an artificial nail having a three-dimensional ornament attached thereto, including: a sticker main body including a flexible planar film layer, and an adhesive layer provided with an adhesive component on both surfaces thereof and attached to the lower surface of the film layer; a three-dimensional ornament attached to the top of the sticker main body by an ornament attachment system operating along a programmed trace; and an artificial nail formed into a fingernail shape and having the sticker main body attached to the top surface thereof, wherein the planar sticker main body provided with the three-dimensional ornament is attached to the top surface of the artificial nail having a curved shape. The artificial nail having a three-dimensional ornament attached thereto realizes uniform adhesion strength between the three-dimensional ornament and the artificial nail. Additionally, the three-dimensional ornament is attached to the artificial nail at a uniform position, and the attachment of the ornament requires a shorter period of time as compared to manual attachment, resulting in an improvement in time-efficiency of the manufacture of the artificial nail having a three-dimensional ornament attached thereto.

### CROSS-REFERENCE TO RELATED APPLICATIONS

This application claims priority under 35 U.S.C. §119 to Korean Patent Application No. 10-2010-0118829, filed on Nov. 26, 2010, in the Korean Intellectual Property Office, the disclosure of which is incorporated herein by reference in its entirety.

### TECHNICAL FIELD

The following disclosure relates to an artificial nail having a three-dimensional ornament attached thereto. More particularly, the following disclosure relates to an artificial nail having a three-dimensional ornament attached thereto and obtained in a short period of manufacturing time, wherein the three-dimensional ornament attached to the artificial nail has uniform adhesion strength and position.

### BACKGROUND

In general, artificial nail users attach various types of artificial nails to their fingernails in order to modify the lengths or shapes thereof. Among the artificial nails produced for these purposes, some artificial nails having three-dimensional ornaments, such as jewels, attached thereto to realize improved appearance have been obtained by manually attaching the three-dimensional ornaments directly to the artificial nails. In this case, since the amount of work carried out by a worker is limited, manufacture of such artificial nails having three-dimensional ornaments attached thereto requires a long period of time. In addition, such time-consuming manual work of manufacturing artificial nails inevitably results in an increase in cost. Moreover, depending on the worker's condition, accuracy of the positions where the ornaments are attached and the force applied to attach the ornaments are changed from time to time. Therefore, in the case of artificial nails having three-dimensional ornaments attached manually thereto, there is a problem in that the artificial nails are hardly provided with three-dimensional ornaments having uniform shape and durability.

According to the related art, in order to solve the above-mentioned problem, artificial nails having dents are injection molded, and then three-dimensional ornaments are inserted manually into the dents so that the three-dimensional ornaments are mounted at a predetermined position. However, in this case, selection of three-dimensional ornaments matched with the dents in size requires a certain period of time. In addition, when three-dimensional ornaments with various sizes are to be used, the mold for artificial nails should be exchanged accordingly, resulting in an increase in manufacturing cost. Moreover, when three-dimensional ornaments are attached to artificial nails by using a mechanical system, a complicated process is required since three-dimensional coordinates should be used as input values for programming the positions where the three-dimensional ornaments are attached since the artificial nails have a curved shape. Further, when the artificial nails are pressurized repeatedly for attaching three-dimensional ornaments through a mechanical system, the artificial nails having a curved shape may be deformed or damaged.

Therefore, there is a need for providing an artificial nail having a three-dimensional ornament attached thereto at a uniform adhesion position with uniform adhesion strength, and obtained in a short processing time, as well as a method for manufacturing artificial nails capable of preventing deformation of artificial nails.

### SUMMARY

An embodiment of the present disclosure is directed to providing an artificial nail having a three-dimensional ornament attached thereto at a uniform position with uniform strength.

Another embodiment of the present disclosure is directed to providing a method for manufacturing artificial nails, which allows mass production of uniform-quality artificial nails having three-dimensional ornaments attached thereto.

In one general aspect, an artificial nail having a three-dimensional ornament attached thereto includes: a sticker main body including a flexible planar film layer, and an adhesive layer provided with an adhesive component on both surfaces thereof and attached to the lower surface of the film layer; a three-dimensional ornament attached to the top of the sticker main body by an ornament attachment system operating along a programmed trace; and an artificial nail formed into a fingernail shape and having the sticker main body attached to the top surface thereof, wherein the planar sticker main body provided with the three-dimensional ornament is attached to the top surface of the artificial nail having a curved shape.

According to one embodiment, the adhesive layer has an adhesion force ranging from 900 gf/25 mm to 3000 gf/25 mm.

The film layer may have a tensile elongation of 30% to 400%.

In addition, the film layer may have a tensile strength of 100 MPa to 400 MPa.

In another general aspect, a method for manufacturing an artificial nail having a three-dimensional ornament attached thereto includes: providing a sticker main body including a planar film layer and an adhesive layer formed on the bottom surface of the film layer, and a release sheet capable of preventing adhesion of foreign materials to the adhesive layer; cutting the sticker main body into a fingernail shape; attaching a three-dimensional ornament to the top surface of the sticker main body while moving the ornament along a programmed trace; separating the release sheet from the sticker main body to which the ornament is attached; and attaching the sticker main body to the top surface of an artificial nail with a curved shape.

According to an embodiment, a hot fix type adhesive capable of being molten by ultrasonic waves or heaters may be provided on the bottom surface of the three-dimensional ornament.

More particularly, when attaching the ornament to the sticker main body, the three-dimensional ornament may be pressurized against the sticker main body for 0.1 second to 0.5 second, while the adhesive is in a molten state.

In addition, the adhesive may include an ethylene vinyl acetate (EVA) copolymer-, polyamide-, polyurethane- or rubber-based adhesive.

Other features and aspects will be apparent from the following detailed description, the drawings, and the claims.

### BRIEF DESCRIPTION OF THE DRAWINGS

The above and other objects, features and advantages of the present disclosure will become apparent from the following description of certain exemplary embodiments given in conjunction with the accompanying drawings, in which:

FIG. 1 is a perspective view of the artificial nail having a three-dimensional ornament attached thereto according to an exemplary embodiment;

FIG. 2 is a flow chart showing the method for manufacturing an artificial nail according to an exemplary embodiment; and

FIG. 3 is a schematic view illustrating the method for manufacturing an artificial nail according to an exemplary embodiment.

[Detailed Description of Main Elements]

| 100: | artificial nail having three-dimensional ornament | |
|---|---|---|
| | attached thereto | |
| 110: | film layer | 120: adhesive layer |
| 130: | three-dimensional ornament | 140: adhesive |
| 150: | artificial nail | P: release sheet |

### DETAILED DESCRIPTION OF EMBODIMENTS

The advantages, features and aspects of the present disclosure will become apparent from the following description of the embodiments with reference to the accompanying drawings, which is set forth hereinafter. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art. The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Hereinafter, exemplary embodiments will be described in detail with reference to the accompanying drawings.

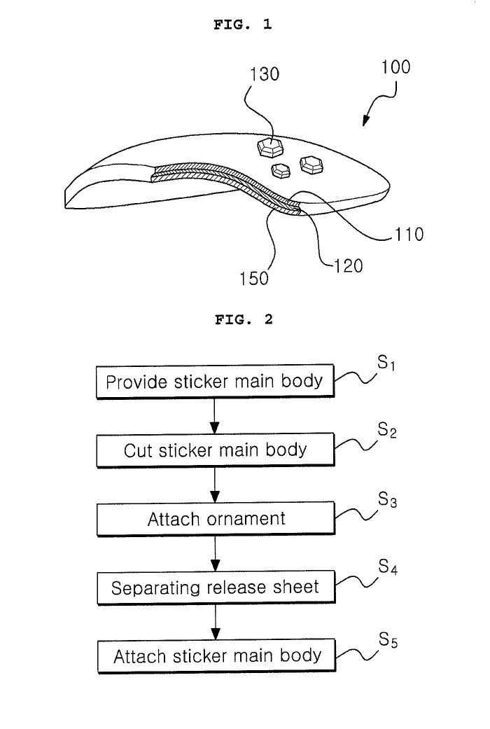

FIG. 1 is a perspective view of the artificial nail having a three-dimensional ornament attached thereto according to an exemplary embodiment.

As shown in FIG. 1, the artificial nail 100 having a three-dimensional ornament attached thereto includes: a sticker main body including a flexible planar film layer 110, and an adhesive layer 120 provided with an adhesive component on both surfaces thereof and attached to the lower surface of the film layer 110; a three-dimensional ornament 130 attached to the top of the sticker main body by an ornament attachment system 5 operating along a programmed trace; and an artificial nail 150 formed into a fingernail shape and having the sticker main body attached to the top surface thereof, wherein the planar sticker main body provided with the three-dimensional ornament 130 is attached to the top surface of the artificial nail 150 along the curved surface of the artificial nail 150.

According to the above-described artificial nail 100 having a three-dimensional ornament attached thereto, the three-dimensional ornament 130 is attached first to the planar film layer 110 capable of being formed into a two-dimensional shape, and then the resultant sticker main body having the three-dimensional ornament 130 attached thereto is adhered to the artificial nail 150 having a curved shape. In this manner, the three-dimensional ornament 130 is located at a position according to a simplified two-dimensional program, not three-dimensional one. As a result, it is possible to attach the three-dimensional ornament 130 to the artificial nail 150 by using an ornament attachment system 5. In other words, unlike the known artificial nails having jewels attached directly to the curved surfaces of artificial nails 150, the artificial nail 100 having a three-dimensional ornament attached thereto disclosed herein permits the three-dimensional ornament 130 to be located on the artificial nail in a simplified manner, since the three-dimensional ornament 130 is attached first to the planar film layer 110 before the sticker main body is adhered to the artificial nail 150.

The artificial nail 100 having a three-dimensional ornament attached thereto includes a film layer 110 having a tensile elongation of 30% to 400% and a tensile strength of 100 Pa to 400 MPa. The use of such a film layer prevents wrinkle formation during the attachment of the sticker main body to the top surface of the artificial nail 150, and maintains air-tight contact between the sticker main body and the curved artificial nail 150.

Herein, ‘tensile elongation’ is a measure of the amount of stretch or elongation of a specimen, and is expressed as a percentage of increase in length when a standard specimen is broken after it is drawn at a predetermined speed by a tensile tester. The tensile elongation of the film layer 110 is in accordance with the tensile test for thin plastic sheets as defined by the American Society for Testing And Materials D882 (ASTM D882). When the film layer has a tensile elongation less than 30%, it is difficult to allow the sticker main body to be in close contact with the curved surface of the artificial nail 150, because the planar film layer 110 cannot be elongated to the curvature of the artificial nail 150. On the other hand, when the film layer 110 has a tensile elongation greater than 400%, the film layer 110 may be elongated easily while it is attached to the artificial nail, resulting in wrinkling, separation of the film layer 110 from the artificial nail 150, and elongation and deformation of the film layer 110 after the film layer is attached to the artificial nail. Therefore, the film layer 110 may have a tensile elongation of 30% to 400%.

And, ‘tensile strength’ is a measure of the maximum stress that a specimen can endure. When the sticker main body is elongated, the film layer 110 may have a tensile strength of 100 MPa to 400 MPa. The tensile strength of the film layer 110 is also in accordance with ASTM D882. When the film layer 110 has a tensile strength less than 100 MPa, the film layer 110 may be deformed easily when applying tensile force to allow the sticker main body to be in close contact with the artificial nail 150. On the other hand, when the film layer 110 has a tensile strength greater than 400 MPa, the film layer 110, due to the lack of ductility, cannot undergo elongation sufficient to realize a close contact with the artificial nail 150. Therefore, the film layer 110 may have a tensile strength of 100 MPa to 400 MPa.

The adhesive layer 120 provided on the bottom of the film layer 110 may have an adhesion force ranging from 900 gf/25 mm to 3000 gf/25 mm. When the adhesive layer 120 has an adhesion force less than 900 gf/25 mm, the sticker main body may be separated from the artificial nail 150 with ease. Moreover, if the restorability of the film layer 110 used in the sticker main body is higher than the adhesion force, the sticker main body may be detached easily from the artificial nail 150. And, when the adhesive layer 120 has an adhesion force greater than 3000 gf/25 mm, the user's fingernail may be damaged while the artificial nail 100 having a three-dimensional ornament is detached from the user's fingernail for the purpose of exchange. Therefore, the adhesive layer 120 may have an adhesion force ranging from 900 gf/25 mm to 3000 gf/25 mm. Herein, the adhesion force expressed by the unit of gf/25 mm is based on the adhesion test carried out by using a sample with a width of 25 mm, and N/25 mm may also be used as the unit of the adhesion force.

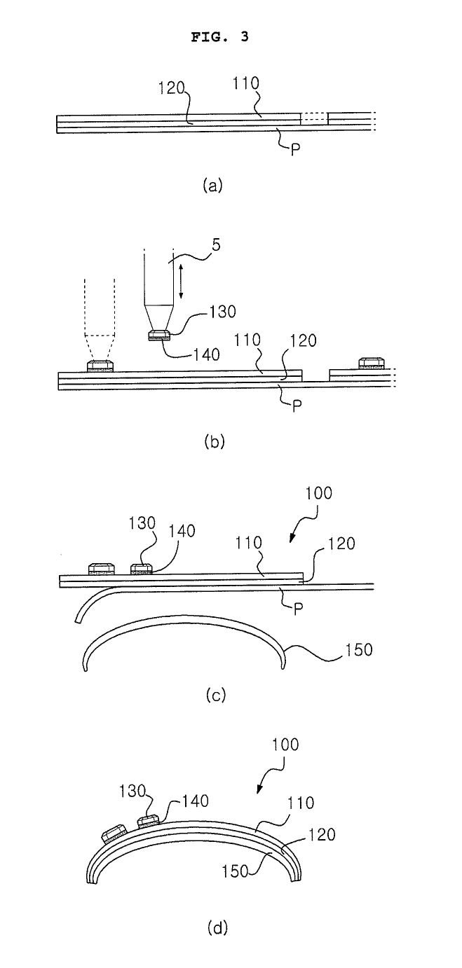

FIG. 2 is a flow chart showing the method for manufacturing an artificial nail according to an exemplary embodiment. FIG. 3 is a schematic view illustrating the method for manufacturing an artificial nail according to an exemplary embodiment.

The artificial nail 100 having a three-dimensional ornament attached thereto may be obtained by the method for manufacturing an artificial nail as shown in FIG. 2. The method for manufacturing an artificial nail includes: providing (S₁) a sticker main body including a planar film layer 110 and an adhesive layer 120 formed on the bottom surface of the film layer 110, and a release sheet P capable of preventing adhesion of foreign materials to the adhesive layer 120; cutting (S₂) the sticker main body into a fingernail shape; attaching (S₃) a three-dimensional ornament 130 to the top surface of the sticker main body while moving the ornament along a programmed trace; separating (S₄) the release sheet P from the sticker main body to which the ornament is attached; and attaching (S₅) the sticker main body to the top surface of an artificial nail 150 with a curved shape.

According to the method for manufacturing an artificial nail, as shown in portion (a) of FIG. 3, a sticker main body having a release sheet P on the bottom surface thereof is provided first, in operation S₁ for forming a sticker main body. Next, the sticker main body is cut in operation S₂. Herein, the sticker main body may be cut into various sizes. The sticker main body cut into a fingernail shape is retained on the release sheet P, while the remaining portion of the sticker main body is removed.

The sticker main body cut into a fingernail shape has a flat planar shape, and thus allows the three-dimensional ornament to be provided at a constant height. Therefore, as shown in portion (b) of FIG. 3, the position where the three-dimensional ornament 130 is located may be determined in a two-dimensional scale. Such simplified two-dimensional positioning of the three-dimensional ornament 130 permits the use of an ornament attachment system 5 in providing the three-dimensional ornament 130 automatically to the sticker main body. The three-dimensional ornament 130 is provided with an adhesive 140 on the bottom surface thereof, and particular examples of the adhesive may include hot fix type adhesives capable of adhesion while they are molten by ultrasonic waves, heaters, or the like.

Herein, the three-dimensional ornament 130 may be loaded on the sticker main body for 0.1 second to 0.5 second. The hot fix type adhesives used as the adhesive 140 usually has a melting point as high as at least 100° C. Thus, when the ornament loading time exceeds 0.5 second, the sticker main body may undergo thermal deformation. On the other hand, when the ornament loading time is less than 0.1 second, the three-dimensional ornament 130 may not be attached firmly to the sticker main body. Therefore, when the hot fix type adhesives 140 are used, the loading time of the three-dimensional ornament 130 onto the sticker main body may range from 0.1 second to 0.5 second. More particularly, the hot fix type adhesives 140 that may be used herein include ethylene vinyl acetate (EVA) copolymer-, polyamide-, polyurethane- and rubber-based adhesives. The adhesive 140 may have a strength of 10 MPa-80 MPa so that the adhesion to the sticker main body made by the adhesive is maintained reliably. When the strength is less than 10 MPa, the three-dimensional ornament 130 may be detached from the sticker main body with ease. On the other hand, when the strength is greater than 80 MPa, the sticker main body may undergo partial interlayer separation along the adhesive, due to the strong tendency of the adhesive to maintain its initial planar state, while the sticker main body is transformed into a curved shape so as to be attached to the artificial nail. Therefore, the adhesive 140 may have a strength ranging from 10 MPa to 80 MPa.

After the completion of the adhesion of the three-dimensional ornament 130 to the sticker main body, as shown in portion (c) of FIG. 3, the release sheet P is detached from the sticker main body. Then, as shown in portion (d) of FIG. 3, the sticker from which the release sheet P is removed is allowed to be in close contact with the top of the artificial nail 150 with a curved shape, thereby providing a finished artificial nail.

Since the ornament attachment system 5 pressurizes the three-dimensional ornament 130 with constant pressure, it is possible to apply uniform adhesion force to the three-dimensional ornament 130 attached to the sticker main body while the adhesive 140 is pressurized under constant force. Moreover, since the three-dimensional ornament 130 is attached to the sticker main body while the ornament 130 or the sticker main body is moved along the initially programmed position, it is possible to attach the three-dimensional ornament 130 to the sticker main body at a uniform adhesion position in operation S₄.

In other words, according to the above-described artificial nail 100 having a three-dimensional ornament attached thereto and the method for manufacturing an artificial nail, the three-dimensional ornament 130 is attached to the artificial nail 150 through the adhesion of the sticker main body to the artificial nail 150. Therefore, unlike the related art requiring manual attachment of ornaments, it is possible to attach the three-dimensional ornament, such as jewel, to the artificial nail 150 by using an ornament attachment system 5. As a result, it is possible to manufacture the artificial nail having a three-dimensional ornament attached thereto in a short period of time, and to provide the artificial nail with a high degree of completion and a uniform shape.

As described above, according to the artificial nail disclosed herein, a three-dimensional ornament is attached to a planar sticker main body before the sticker main body is attached to the artificial nail with a curved shape. Thus, it is possible to use an ornament attachment system for attaching a three-dimensional ornament to an artificial nail, while realizing uniform adhesion strength between the three-dimensional ornament and the artificial nail. Further, the three-dimensional ornament may be attached to the artificial nail at a uniform position, and such attachment of the ornament requires a shorter period of time as compared to manual attachment, resulting in an improvement in time-efficiency of the manufacture of the artificial nail having a three-dimensional ornament attached thereto.

While the present disclosure has been described with respect to the specific embodiments, it will be apparent to those skilled in the art that various changes and modifications may be made without departing from the spirit and scope of the invention as defined in the following claims.

What is claimed is:

1. An artificial nail having a three-dimensional ornament attached thereto, comprising:
a sticker main body including a flexible planar film layer, and an adhesive layer provided with an adhesive component on both surfaces thereof and attached to the lower surface of the film layer;
a three-dimensional ornament attached to the top of the sticker main body by an ornament attachment system operating along a programmed trace; and
an artificial nail formed into a fingernail shape and having the sticker main body attached to the top surface thereof,
wherein the planar sticker main body provided with the three-dimensional ornament is attached to the top surface of the artificial nail having a curved shape.

2. The artificial nail having a three-dimensional ornament attached thereto according to claim 1, wherein the adhesive layer has an adhesion force ranging from 900 gf/25 mm to 3000 gf/25 mm.

3. The artificial nail having a three-dimensional ornament attached thereto according to claim 1, wherein the film layer has a tensile elongation of 30% to 400%.

4. The artificial nail having a three-dimensional ornament attached thereto according to claim 1, wherein the film layer has a tensile strength of 100 MPa to 400 MPa.

5. A method for manufacturing an artificial nail, comprising:
providing a sticker main body including a planar film layer and an adhesive layer formed on the bottom surface of the film layer, and a release sheet capable of preventing adhesion of foreign materials to the adhesive layer;
cutting the sticker main body into a fingernail shape;
attaching a three-dimensional ornament to the top surface of the sticker main body while moving the ornament along a programmed trace;
separating the release sheet from the sticker main body to which the ornament is attached; and
attaching the sticker main body to the top surface of an artificial nail with a curved shape.

6. The method for manufacturing an artificial nail according to claim 5, wherein a hot fix type adhesive capable of being molten by ultrasonic waves or heaters is provided on the bottom surface of the three-dimensional ornament.

7. The method for manufacturing an artificial nail according to claim 6, wherein the three-dimensional ornament is pressurized against the sticker main body for 0.1 second to 0.5 second, while the adhesive is in a molten state, in order to attach the ornament to the sticker main body.

8. The method for manufacturing an artificial nail according to claim 6, wherein the adhesive comprises an ethylene vinyl acetate (EVA) copolymer-, polyamide-, polyurethane- or rubber-based adhesive.
